(19) United States
(12) Patent Application Publication
(10) Pub. No.: US 2025/0071715 A1
(43) Pub. Date: Feb. 27, 2025

(54) TRACKING PURGE INFORMATION FOR DEREGISTRATIONS IN WIRELESS COMMUNICATION NETWORKS

(71) Applicant: T-MOBILE INNOVATIONS LLC, Overland Park, KS (US)

(72) Inventors: Subramania Kaushik, Bellevue, WA (US); Anil Kumar Mariyani, Ashburn, VA (US)

(21) Appl. No.: 18/456,183

(22) Filed: Aug. 25, 2023

(51) Int. Cl. H04W 60/06

(52) U.S. Cl. CPC H04W 60/06

(57) ABSTRACT

Technology is disclosed herein for operating a wireless network including deregistering a user device from the network. In an implementation, a first network element deregisters the user device from the wireless network. The first network element determines a cause of the deregistration from among a plurality of possible causes and generates a notification message indicating the cause of the deregistration. The first network element communicates the notification message to a second network element which purges subscriber data from a data repository of the network and updates a subscriber profile of the user device with the cause of the deregistration. In an implementation, the first network element is an Access and Mobility Management function (AMF), the second network element is a Unified Data Management function (UDM), and the data repository is a Unified Data Repository (UDR) of the network.

### TECHNICAL FIELD

Aspects of the disclosure are related to the field of wireless communication networks and in particular to subscriber data management.

### BACKGROUND

When a user device, such as a smartphone, seeks access to the services of a wireless network, the device initiates a registration process to establish a connection with the network. This registration process allows the network to identify and authenticate the user device, enabling it to provide the appropriate services and manage the device's communication within the network. When the device attaches to the wireless network, a number of steps take place involving a number of different network elements. Among those steps is a mobility manager of the network, such as an AMF or MME, coordinating the registration of the device with the network core and establishing a context for the user device, including the location, security parameters, active sessions, and Quality of Service (QoS) requirements. When registration is complete, the network has provisioned services to the user device.

When the user device is no longer accessing the network, the device is deregistered from the network. Deregistration involves notifying various network elements that the device is no longer active in the network and allowing network resources for the services provisioned to the device to be released. However, user devices may be deregistered from the network for a variety of reasons which may be intentional, such as if the device migrates from 5G service to LTE service, or unintentional, such as if the registration process or initial attachment fails. Understanding how or why devices are deregistered from the network can be an important factor in optimizing network operations.

### OVERVIEW

Technology, including systems, methods, and devices, is disclosed herein for operating a wireless network including deregistering a user device from the network. In an implementation, a first network element deregisters the user device from the wireless network. The first network element determines a cause of the deregistration from among a plurality of possible causes and generates a notification message indicating the cause of the deregistration. The first network element communicates the notification message to a second network element which purges subscriber data from a data repository of the network and updates a subscriber profile of the user device with the cause of the deregistration. In an implementation, the first network element is an Access and Mobility Management function (AMF), the second network element is a Unified Data Management function (UDM), and the data repository is a Unified Data Repository (UDR) of the network.

In an implementation, the cause for deregistering the user device from the network is based on the first network element receiving a relocation request from another network element. In other implementations, the cause for deregistering the user device is based on the first network element determining that a network slice served to the user device is no longer available to the user device. In still other implementations, the first network element may determine the cause for deregistering the user device to be a context fetch failure or a forced re-registration of the user device.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 illustrates an operational environment for deregistering a user device of a wireless network in an implementation.

FIG. 2 illustrates a method of deregistering a user device from a wireless network in an implementation.

FIG. 3 illustrates an operational environment for deregistering a user device of a wireless network in an implementation.

FIG. 4 illustrates an exemplary workflow for deregistering a user device from a wireless network in an implementation.

FIG. 5 illustrates cause codes and purge attributes for deregistering a user device from a wireless network in an implementation.

FIG. 6 illustrates a systems architecture for a wireless network in an implementation.

FIG. 7 illustrates a systems architecture for a network data center of a wireless communication network in an implementation.

FIG. 8 illustrates a computing system suitable for implementing the various operational environments, architectures, processes, scenarios, and sequences discussed below with respect to the other Figures.

### DETAILED DESCRIPTION

Technology is disclosed herein for tracking deregistration information for subscribers when a subscriber device is deregistered from a 5G network. In an implementation of the technology, when a network function, such as an AMF, HSS, or UDM, initiates a deregistration of a user device, and a UDR of the wireless network is tasked by the network with purging subscriber session data associated with the device. The network identifies a cause of the deregistration event based on the network element requesting or initiating the deregistration and conditions giving rise to the deregistration. The network transmits information relating to the cause of the deregistration to the UDR for recording. The UDR records two attributes, a purge state attribute and a purge cause attribute, in the subscriber profile of the device. The purge state is a Boolean flag which indicates the state of the subscriber data, while the purge cause is an attribute including one of a set of values which indicates a specific cause of the deregistration triggering the purge. In various implementations, the network UDM transmits a cause code to the UDR which the UDR uses to update the purge cause attribute.

In a brief example, when an AMF detects a condition for deregistering the AMF from the user device. For example, the AMF may determine that the user device has migrated from 5G service to LTE service, for example, by performing a handover to an MME of the LTE network. Upon detecting the deregistration condition, the AMF sends a deregistration command or request to the UDM including an encoded message or field which indicates the cause of the deregistration. In response, the UDM updates the purge state attribute in the UDR to “True” to indicate that subscriber data has been purged from the UDR and the purge cause attribute in the UDR to the particular code which indicates the reason for the purge-that the user device has moved from 5G service to LTE service. Recording the causes which trigger the deregistration of a user device helps network operators to more efficiently and effectively track user device behavior to identify and troubleshoot issues causing device deregistration and to optimize network operations accordingly.

A user device may be deregistered from a 5G network and/or an AMF of a 5G network by various network elements and for various reasons. When the device is deregistered from the network, the UDM causes subscriber data (e.g., session data) to be purged from the UDR. In addition, an attribute relating to the purged state of the subscriber data is recorded in the subscriber profile, along with a cause code. In some implementations, the attributes are labeled “purgeFlag” and “purgeCause.” although other labels may be used. As described in the various scenarios below, the examples of the cause code messages and attribute values are for illustration and are non-limiting.

In an exemplary scenario, a user device registers with or attaches to LTE service of a wireless network. In doing so, an HSS of the LTE network may signal to the UDM to deregister the user device from 5G service including the cause code “UE_INITIAL REGISTRATION.” Upon receiving the deregistration request, the UDM instructs the UDR to purge subscriber data from storage while setting a purgeFlag of the device's subscriber profile to “True.” In addition to setting the purgeFlag attribute, the UDM causes the UDR to set an attribute relating to the cause of the purge (e.g., a “purgeCause” attribute) to an encoded value reflecting the reason for the deregistration. For example, the UDM may instruct the UDR in the purge or deregistration request to store the value “InitReg” for the purgeCause attribute. To record a value for the attribute relating to the cause of a data purge, the UDM may send an HTTP request (e.g., PUT or POST) via an application programming interface (API) to the UDR.

In a similar scenario, when a user device migrates from the 5G service to the LTE service of a wireless network, the AMF of the 5G network that had been serving the user device may signal to the UDM to deregister the user device using a cause code of “SUBSCRIPTION_WITHDRAWAL-5GS_TO_EPS_MOBILITY.” Upon receiving the deregistration request from the AMF, the UDM instructs the UDR to set the purgeFlag attribute to “True” and to set the purgeCause attribute to “5G2LTEHO.”

In another scenario, when a user device makes an initial attachment to a new AMF (different from a previously registered AMF), the UDM may detect the change in the AMF serving the device and transmit a deregistration request to the UDR with respect to the old AMF and including a “UE_INITIAL_REGISTRATION” cause code in the request. In this scenario, the UDM requests the UDR to store purgeFlag attribute as “True” and to store the value “InitReg” for the purgeCause to indicate that a new registration has been performed for the device and thus the old registration was deleted.

In yet another scenario, when an AMF of a 5G network is no longer able to provide service corresponding to a particular network slice to a user device, such as if the user device is no longer authorized for the network slice due to a subscription change, the AMF may signal the status change or deregistration to the UDM using a cause code message of “UE REGISTRATION AREA_CHANGE.” The UDM in turn signals the UDR to deregister the device with respect to the AMF and to record a purgeFlag value of “True.” Based on the cause code message, the purgeCause attribute is set by the UDR to “AreaChg.”

In still other scenarios, the AMF may signal to the UDM to deregister the user device if the AMF loses contact with the user device or if the AMF must force the user device to re-register, including a cause code of “SUBSCRIPTION_WITHDRAWAL-UE_INITIAL_REGISTRATION” or “REREGISTRATION_REQUIRED,” respectively. In these scenarios, the UDM requests the UDR store a purgeCause attribute value of “ForedInitReg” or “ReReg,” respectively.

The technical benefit of the technology disclosed herein enabling network operators to track more efficiently the causes of device deregistration, to better understand user device behavior with respect to why devices are deregistered from the network, and, ultimately, to optimize network operations to accommodate those behaviors. By storing a cause for deregistration, statistical analyses can be performed to identify patterns in user behavior relating to when and why deregistration occurs, and to debug or troubleshoot network operations if anomalous behavior (e.g., excessive forced re-registrations) is detected. Absent the ready availability that the deregistration tracking data allows, network operators may be required to dig into log streams of subscriber data to ferret out details of the device behavior to make inferences with respect to the circumstances of that behavior.

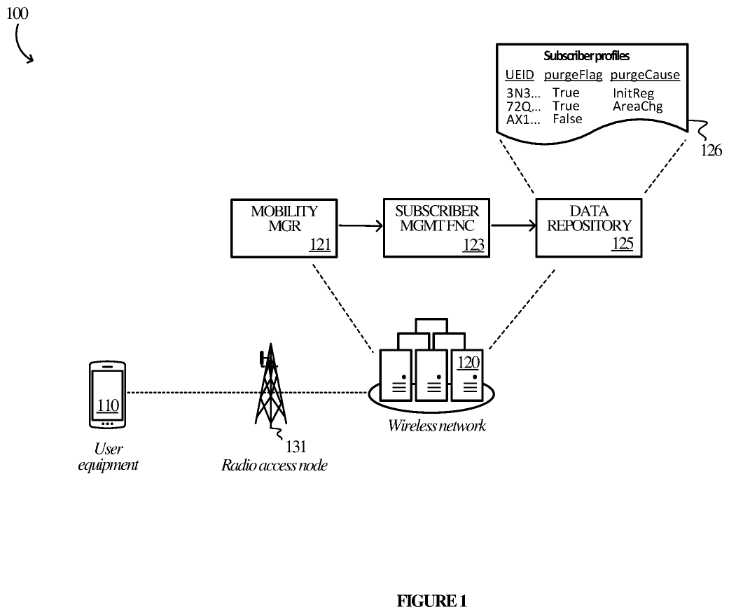

Turning now to the Figures, FIG. 1 illustrates operational environment 100 for tracking device deregistration events in an implementation. Operational environment 100 includes user equipment 110 and wireless network 120. Wireless network 120 includes radio access node (RAN) 131 and network functions including mobility manager 121, subscriber management function 123, and data repository 124. Data repository 124 stores network data including subscriber session data and subscriber profile data 125.

User equipment 110 is representative of smartphones, computers, sensors, controllers, and/or some other user apparatus with processing circuitry for wireless communication. UE 110 exchanges wireless communication signals with RAN 131 over radio frequency bands. RAN 131 is representative of equipment using radio frequencies to provide wireless connectivity to devices, such as Fifth Generation (5G) RANs, long-term evolution (LTE) RANs, gNodeBs, eNodeBs, NB-IoT access nodes, LP-WAN base stations, wireless relays, Wifi access nodes, Wifi hotspots, ENET access nodes, Bluetooth access nodes, and/or other wireless or wireline network transceivers.

UE 110 and RAN 131 are representative of wireless communication devices or radios which wirelessly communicate using protocols such as Fifth Generation New Radio (5GNR), 5G Advanced, 6G, 6G Advanced, LTE, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). RAN 131 may also include other types of access nodes, such as a WLAN access nodes, and communication with home network 120 may be relayed through a Non-3GPP Inter-Working Function (N3IWF) network function (not shown) of the respective network.

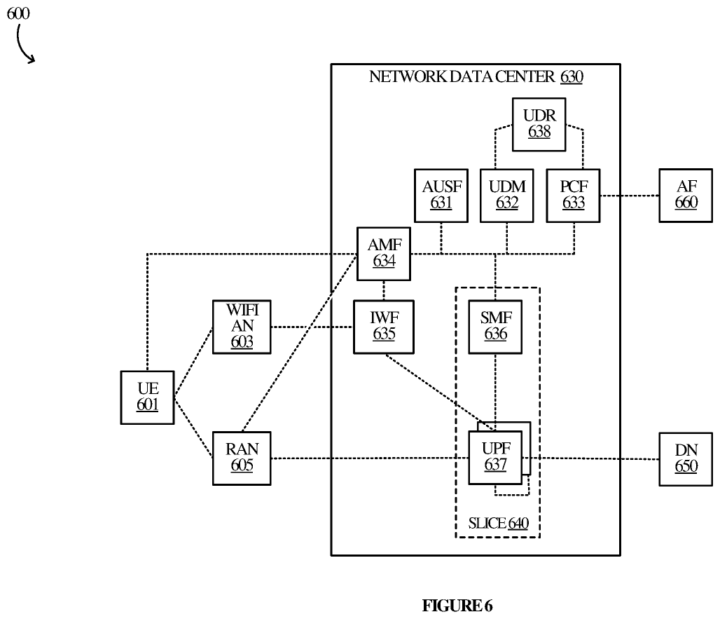

Wireless network 120 is representative of a network capable of using a Fifth Generation New Radio (5GNR), 6G, or LTE protocol to communicate with UE 110 via a RAN, such as RAN 131. In an implementation, wireless network 120 is representative of a service-based architecture (SBA) which includes network functions which constitute the control plane and user plane of a wireless communication network core. The network functions are implemented on one or more suitable computing devices, of which computing device 801 of FIG. 6 is representative. Examples of suitable computing devices include server computers, blade servers, and the like. The network elements of wireless network 120 may be implemented in the context of one or more data centers, in a co-located or distributed manner, or in some other arrangement.

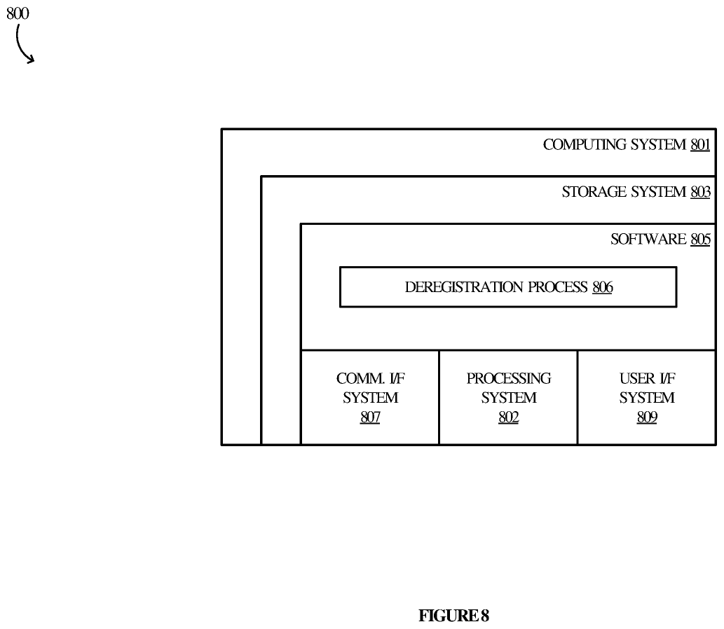

Data repository 124 is representative of a network function or element of wireless network 120 which stores data including subscriber data for retrieval and exposure by other network functions (not shown). Data repository 124 can include a Unified Data Repository (UDR), Unstructured Data Storage Function (UDSF), Home Subscriber System (HSS), or other data storage apparatus. Data repository 124 may be implemented on one or more suitable computing devices, of which computing device 801 of FIG. 8 is representative. Examples include server computers, blade servers, and the like.

Mobility manager 121 is representative of network functions, such as an Access and Mobility Management Functions (AMFs) or Mobility Management Entities (MMEs), which control the exchange of the user data from a user device, such as UE 110, over RAN 131 based on a subscriber profile of the device. For example, mobility manager 121 handles the initial attachment of a user device, manages the mobility of the device, and maintains context information for the device.

Subscriber management function 123 is representative of network functions, such as a Unified Data Management functions (UDMs) or a Home Subscriber Servers (HSSs), which are responsible for storing, managing, and providing access to user-related data and subscription information. For example, subscriber management function 123 manages user subscription profiles, service data handling, and subscriber data handling. Subscriber management function 123 interacts with data repository 124 to manage the handling of subscriber session data, context information, subscriber profiles, and so on.

In operation, UE 110 registers with wireless network 120 via RAN 131 for 5G service, such as a 5G voice call. Subsequent to the attachment of UE 110 for 5G service, a network element of wireless network 120 determines that UE 110 is to be deregistered from the network or from an AMF to which UE 110 registered, including purging subscriber data for UE 110 from data repository 124. In some scenarios, the deregistration arises from UE 110 accessing LTE service from wireless network 120. For example, mobility manager 121 may detect UE 110's attachment to an MME of the LTE network of wireless network 120, triggering the deregistration. In another scenario, a network slice that was served by mobility manager 121 may be deauthorized for UE 110. In still another scenario, subscriber management function 123 may trigger deregistration based on a change in the mobility management function (e.g., the AMF) that is serving UE 110. Subscriber management function 123 sends to data repository 124 a request to record the cause of the deregistration in the subscriber profile for UE 110. In response, data repository 124 assigns a value to an attribute in the profile which indicates the particular reason for the deregistration or data purge.

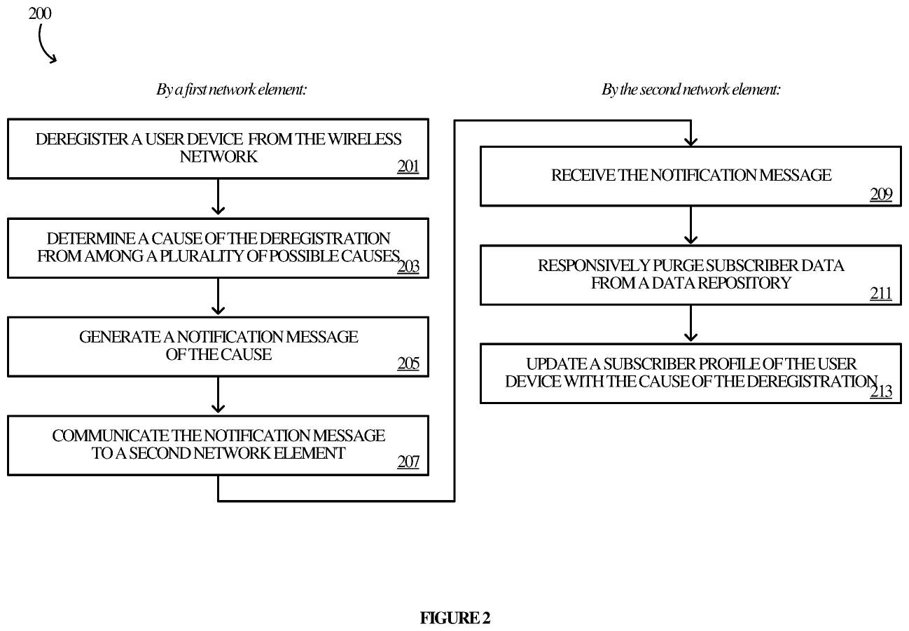

FIG. 2 illustrates process 200 for operating a wireless network including deregistering a user device from the network in an implementation. Process 200 may be implemented on one or more computing devices, such as server computers or computers in the context of a network data center, according to program instructions which direct the computing devices to function as follows, referring parenthetically to the steps in FIG. 2 and in the singular for the sake of clarity.

A first network element of a wireless network deregisters a user device from the network (step 201). In an implementation, the first network element is a network function that manages access and mobility of a user device within the wireless network, such as an AMF of a 5G network. To deregister the device, the first network element initiates a deregistration process when it detects that the user device is disconnected from the network. The first network element terminates any ongoing sessions or connections of the user device and updates its records to remove any context information associated with the user device, such as information about the device's location, active sessions, security parameters, and QoS requirements. The first network element also releases network resources and invalidates authentication credentials and security keys associated with the user device. The first network element also sends information to other elements of the network core regarding the device's status and sends a confirmation of deregistration to the user device.

The first network element determines a cause of the deregistration from among a plurality of possible causes (step 203). In an implementation, a deregistration arises when the user device is no longer connected to the first network element. In an implementation, the first network element identifies the cause of the deregistration from among a set of possible deregistration causes. The causes or conditions which give rise to deregistering the user device include the user device migrating from 5G service to LTE service (e.g., an AMF receives a handover or relocation request from an MME); that the device registration with the first network element has failed (e.g., an initial attachment to the AMF failed or a context fetch by the AMF for the device has failed); that the first network element has forced the user device to re-register; or that a network slice provided by the first network element to the user device is no longer available to the user device, making a new registration necessary.

In some scenarios, the cause or condition for deregistering the user device from the network arises from the device attaching an LTE network of the wireless network. For example, an HSS of the LTE network may send a registration request to a UDM of the network. In other scenarios, the cause for deregistration is that the UDM has receiving a registration request from an AMF that is different from the AMF that the device was previously registered to.

Upon determining the cause of the deregistration, the first network element generates a notification message including the cause of the deregistration (step 205). In an implementation, the notification message includes a cause code corresponding to the cause of the deregistration. The first network element then communicates the notification message to a second network element of the wireless network that manages subscriber data for the user device (step 207). In various implementations, the second network element is a UDM which manages subscriber data associated with the user device, including handling storage and retrieval of subscriber and other data for the device from a UDR.

The second network element receives the notification message from the first network element (step 209), and in response, purges subscriber data from a data repository of the wireless network (step 211). In an implementations, the second network element is a UDM which manages storage and retrieval of subscriber data for the user device from a UDR.

In an implementation, the second network element submits a request to the network data repository to purge user or subscriber data associated with the user device from storage, including data which associates or registers the device with the first network element (e.g., data which constitutes the registration of the user device with the AMF). The data purged by the data repository may also include context information, session data, authentication data, resource allocation information, service profiles, access authorization, policy and charging data, and user identity and subscription data associated with the user device. In the 5G context, purging the AMF registration information of the user device effects a deregistration of the device from the AMF.

The second network element updates a subscriber profile of the user device with the cause of the deregistration (step 213). In an implementation, to update the subscriber profile with regard to the deregistration, the second network element transmits a request to the network data repository to record a value in a field of the subscriber profile which indicates the cause or cause code that the second network element received from the first network element. For example, in the 5G context, along with the request to purge subscriber data from the UDR, the UDM may instruct the UDR to record a value for an attribute of the subscriber profile of the device which corresponds to the cause of the deregistration that was determined or identified by the AMF (or by another network element, such as an HSS or the UDM itself). In various implementations, the UDR records the purge information or values in fields corresponding to the purge attributes in the subscriber profile.

Referring again to FIG. 1, operational environment 100 illustrates a brief example of process 200 as employed by elements of operational environment 100. In operation, UE 110 accesses wireless network 120 for service, such as 5G or LTE service. In an implementation, mobility manager 121 determines that UE 110 is to be deregistered, including purging subscriber data from data repository 124. Mobility manager 121 performs operations corresponding to deregistering UE 110 and determines a cause for the deregistration. The determination by mobility manager 121 to deregister UE 110 may arise from a number of conditions, each of which is described or classified by a cause code from a set of cause codes or conditions. Mobility manager 121 identifies the particular cause of the deregistration and generates a notification message by which to transmit the cause to subscriber management function 123. The causes or conditions giving rise to deregistration which may be determined by mobility manager 121 include a context fetch or retrieval failure by mobility manager 121, a forced re-registration of UE 110 by mobility manager 121, and a network slice served by mobility manager 121 may be deauthorized for UE 110 (e.g., if UE 110's subscription status has changed). In some implementations, the set of causes or cause codes include a code for deregistration for an unidentified cause.

Upon determining that UE 110 is to be deregistered, mobility manager 121 transmits the notification message to subscriber management function 123 including the cause code for the deregistration. Subscriber management function 123, in turn, sends a message to data repository 124 to purge subscriber data associated with UE 110 and to record an indication of the cause of the deregistration, such as value in a field for storing deregistration causes, in the user profile for UE 110. For example, if the deregistration is due to an unavailable network slice, the cause code may be “UE_REGISTRATION_AREA_CHANGE,” and the value, “AreaChg.” If the deregistration is due to a context fetch failure, the cause code may be “SUBSCRIPTION_WITHDRAWAL-UE_INITIAL_REGISTRATION,” and the value, “ForcedInitReg.” If the deregistration is due to a forced re-registration, the cause code may be “ReReg.”

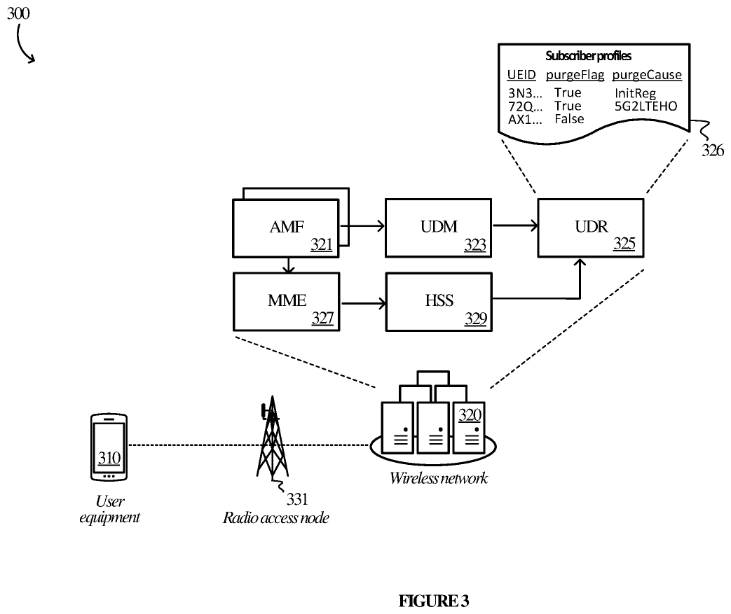

FIG. 3 illustrates wireless communication system 300 that serves wireless user equipment 310 in an implementation. Wireless communication system 300 includes UE 310, RAN 331, and wireless network 320, elements of which include one of more of AMFs 321, UDM 322, and UDR 325, MME 327, and HSS 329. UDR 325 stores network data 326 for wireless network 320 including subscriber data and subscriber profiles for UE 310 and other devices.

In brief operational scenario of the technology disclosed herein, UE 310 accesses wireless network 320 for service, such as 5G or LTE service. In an implementation, AMF 321 determines that UE 310 is to be deregistered, including purging subscriber data from UDR 325 to deregister UE 310 from AMF 321. The determination by AMF 321 to deregister UE 310 from AMF 321 may arise from a number of conditions, each of which is described or classified by a cause code which AMF 321 transmits to UDM 323. The conditions giving rise to deregistration as determined by AMF 321 include the migration of UE 310 from 5G service to LTE service. For example, when UE 310 transitions from the 5G network to the LTE network of wireless network 320, AMF 321 initiates a handover to MME 327 of the LTE network of wireless network 120 based on a relocation request from MME 327. AMF 321 also transmits a message to UDM 323 including a cause code which indicates that the deregistration is related to transition of UE 310 to the LTE network. UDM 323 sends a message to UDR 325 to record an indication, such as value in a field for storing deregistration causes, in the user profile for UE 310 (“72Q . . . ”) of network data 326 indicating the cause of the deregistration (“5G2LTEHO”).

In an alternative scenario, HSS 329 detects that UE 310 has registered for LTE service with MME 327. HSS 329 transmits to UDM 323 a message which indicates that UE 310 has made an initial attachment to the LTE network. In one aspect of the invention, the message includes a cause code which indicates that a deregistration event is to be performed for UE 310. In other aspects, UDM 323 includes logic which identifies that a deregistration is to be performed for UE 310 based on receiving the indication of the initial LTE attachment. In either case, based on receiving the message, UDM 323 initiates a deregistration for UE 310. UDM 323 sends a message to UDR 325 to record an indication, such as value in a field for storing deregistration causes, in the user profile for UE 310 of network data 326 indicating the cause of the deregistration (“InitReg”).

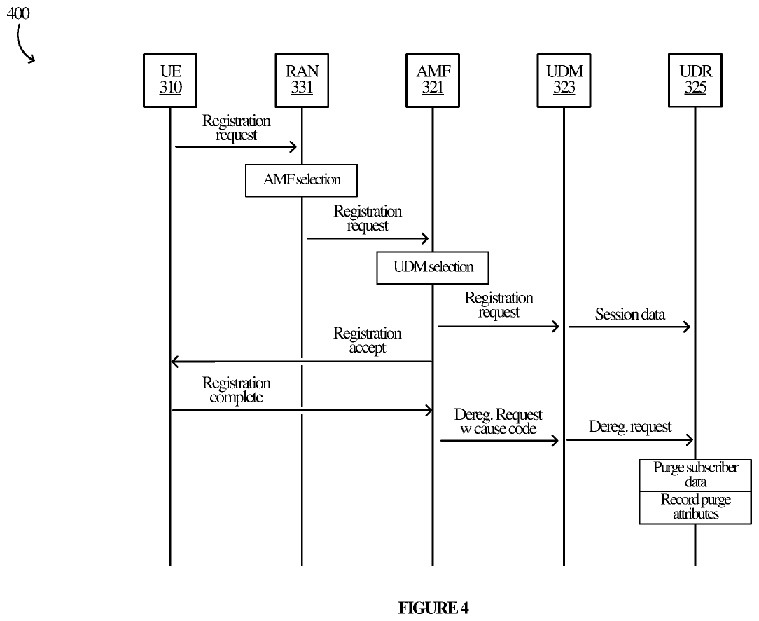

FIG. 4 illustrates in workflow 400 another brief operational scenario of the technology disclosed herein, referring to elements of FIG. 3. In workflow 400, UE 310 registers for service with a wireless network 320 via RAN 331. (It may be appreciated that a number of steps performed by the various network functions of wireless network 320 during device registration are omitted for clarity.) RAN 331 selects an AMF, and the selected AMF, AMF 321, selects UDM 323. When the registration process is complete, UDR 325 will have recorded subscriber data relating to the attachment of UE 310 including the identity of the selected AMF along with other subscriber data, e.g., session data, context information, and so on.

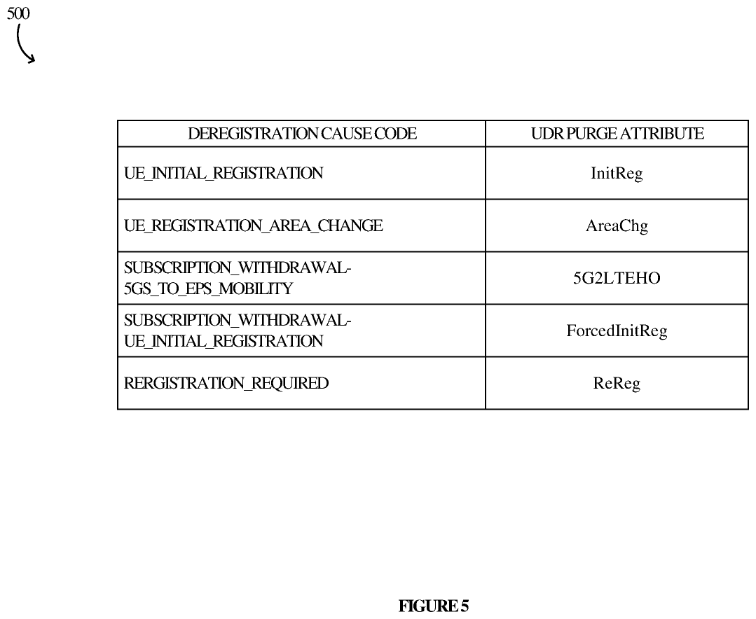

At some time after the attachment to AMF 321. AMF 321 determines that UE 310 is to be deregistered. AMF 321 sends a deregistration request to UDM 323 including an indication of the cause of the deregistration (examples of which are illustrated in FIG. 5). Upon receiving the deregistration request, UDM 323 instructs UDR 325 to perform the deregistration, including deregistering UE 310 from AMF 321, and includes the cause code or other indicator of the cause. Upon receiving the deregistration request, UDR 325 purges subscriber data relating to UE 310 from storage and records a purge status and a cause attribute in the subscriber profile for UE 310. The purge status is a Boolean flag indicating that a purge has been performed on the subscriber data and the cause attribute is an encoded value indicating the cause code received by UDM 323 and/or UDR 325.

FIG. 5 illustrates cause codes which may be transmitted by a network function to a UDM of the network in relation to the deregistration of a user device along with corresponding attribute values. When the UDM receives a cause code, the UDM instructs the UDR to store the corresponding attribute value in a subscriber profile of the user device in conjunction with performing a purge of subscriber data for the user device.

FIG. 6 illustrates wireless communication system 600, of which operational environment 100 of FIG. 1 is representative, that serves wireless User Equipment (UE) 601 in an implementation. Wireless communication system 600 includes UE 601, Wifi Access Node (AN) 603, 5GNR RAN 605, Interworking Function (IWF) 635, Access and Mobility Management Function (AMF) 634, Authentication Server Function (AUSF) 631, Unified Data Management (UDM) 632, Policy Control Function (PCF) 633, Unified Data Repository (UDR) 638, Session Management Function (SMF) 636, User Plane Function (UPF) 637, and Application Function (AF) 660. UDR 638 is representative of computing devices with capabilities for network data storage, of which computing device 801 of FIG. 8 is representative. AF 660 may provide policies applicable to control plane functions, that is, to the application, presentation, and/or session layers of the OSI protocol stack. IWF 635 includes non-3GPP IWFs (N3IWFs) for providing untrusted non-3GPP access to network data center 630, such as access via a non-cellular access network. Wireless network slice 640 includes UPF 637 and SMF 636. DN 650 is representative of a data network, Internet access, third-party resource, or other endpoint of an end-to-end communication path from UE 601.

In an implementation, as UEs such as UE 601 access network data center 630, network functions such as UDM 632 and PCF 633 communicate with UDR 638 to store and receive various types of network data for UEs via an application programming interface (API). In operation, UDM 632 accesses subscription data from UDR 638 via the API using a GET request and records subscription data in UDR 638 using a PUT or POST request. For example, to record a value for an attribute relating to the cause of a data purge, UDM 632 may send a PUT request via the API to UDR 638. Network data stored by UDR 638 includes subscriber profiles including identities, subscription details, service preferences, authentication credentials, and billing information. Subscription data stored by UDR 638 may also include records for voice calls, data sessions, and messaging activities which such information as originating and terminating phone numbers, call duration, timestamps, data usage, and network resources consumed. Subscriber data stored by UDR 638 can also include location data such as geographic coordinates, cell tower information, and GPS data. Subscriber data stored by UDR 638 can also include subscription or service plan, service features, QoS parameters, and service policies as well as roaming data such as roaming agreements, authentication information, visited network details, and billing records. UDR 638 may also store subscriber data including security and fraud data such as authentication logs. In addition to subscriber data, UDR 638 also stores policy data such as network rules, access rules, mobility rules, charging rules, and so on.

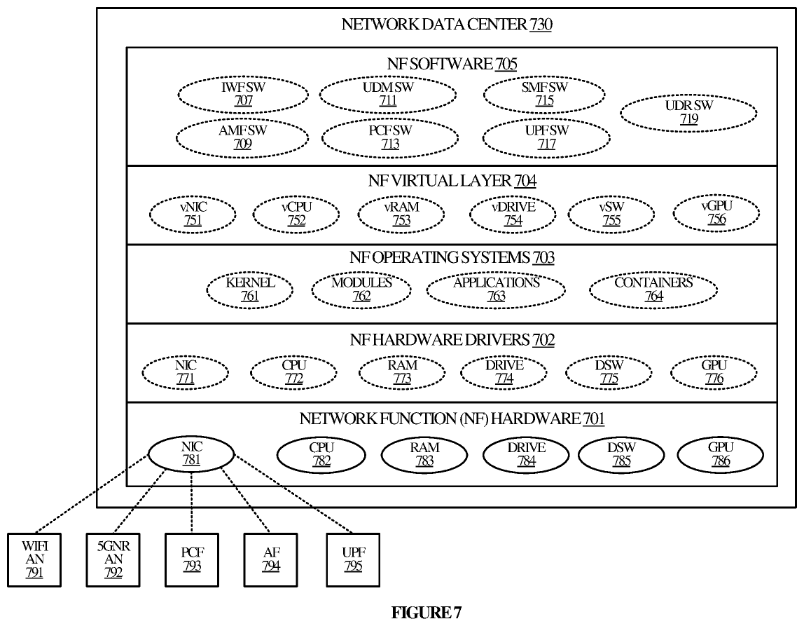

FIG. 7 illustrates exemplary network data center 730, a network core of a wireless communication system of which wireless network 120 of FIG. 1 is representative. Network data center 730 includes network function (NF) software 705, network function virtual layer 704, network function operating systems 703, network function hardware drivers 702, and network function hardware 701.

Network function software 705 of network data center 730 includes software for executing various network functions: IWF software 707, AMF software 709, UDM software 711, PCF software 713, SMF software 715, UPF software 717, and UDR software 719. Other network function software, such as network repository function (NRF) software, are typically present but are omitted for clarity. In various implementations, elements of network data center 730, such as UDM software 711 and UDR software 719, perform deregistration processes described herein, such as process 200 of FIG. 2, on one or more computing devices of which computing device 801 of FIG. 8 is representative.

Network function virtual layer 704 includes virtualized components of network data center 730, such as virtual NIC 751, virtual CPU 752, virtual RAM 753, virtual drive 754, virtual software 755, and virtual GPU 756. Network operating systems 703 includes components for operating network data center 730, including kernels 761, modules 762, applications 763, and containers 764 for network function software execution. Network function hardware drivers 702 include software for operating network function hardware 701 of network data center 730, including network interface card (NIC) drivers 771 for network interface cards (NICs) 781, CPU drivers 772 for CPUs 782, RAM drivers 773 for RAM 783, flash/disk drive drivers 774 for flash/disk drives 784, data switch (DSW) drivers 775 for data switches 785, and drivers 776 for GPUs 786. Network interface cards 781 of network function hardware 701 include hardware components for communicating with Wifi access node 791, 5GNR access node 792, PCF 793, application server 794, and UPF 795.

Turning now to FIG. 8, architecture 800 illustrates computing device 801 that is representative of any system or collection of systems in which the various processes, programs, services, and scenarios disclosed herein may be implemented. Examples of computing device 801 include, but are not limited to, server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements deregistration process 806, which is representative of the deregistration processes discussed with respect to the preceding Figures, such as process 200. When executed by processing system 802, software 805 directs processing system 802 to operate as described herein for at least the various processes, operational scenarios, and sequences discussed in the foregoing implementations. Computing device 801 may optionally include additional devices, features, or functions not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, which are capable of communicating with processing system 802 or possibly other systems.

Software 805 (including deregistration process 806) may be implemented in program instructions and among other functions may, when executed by processing system 802, direct processing system 802 to operate as described with respect to the various operational scenarios, sequences, and processes illustrated herein. For example, software 805 may include program instructions for implementing the device deregistration processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support device deregistration processes and operations. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary, etc.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless communication network, comprising:
in a first network element that manages mobility of user devices within the wireless communication network:
deregistering the user devices from the wireless communication network;
determining causes of the deregistering and generating notification messages indicative of the causes of the deregistering of the user devices; and
communicating the notification messages to a second network element that manages subscription data handling for the wireless communication network;
in the second network element:
receiving the notification messages;
responsively purging subscriber data associated with the user devices from a data repository; and
updating subscriber profiles associated with the user devices with the causes of the deregistering.

2. The method of claim 1, wherein determining the causes of the deregistering comprises, for each of the user devices, determining a cause of the deregistering from among a plurality of possible causes.

3. The method of claim 2, wherein generating the notification messages comprises, for each of the user devices, generating a notification message comprising a cause code indicative of the cause of the deregistering.

4. The method of claim 3, wherein the wireless communication network comprises a Fifth-Generation (5G) network, and wherein the first network element comprises an Access and Mobility Management function (AMF) of a 5G network.

5. The method of claim 4, wherein the second network element comprises a Unified Data Management function of the 5G network.

6. The method of claim 5, wherein the wireless communication network further comprises a long-term evolution (LTE) network, and wherein the plurality of possible causes includes a handover request from a Mobility Management Element of the LTE network.

7. The method of claim 6, wherein the plurality of possible causes further includes: an initial attachment by the user device to a data repository element of the LTE network.

8. The method of claim 7, wherein the plurality of possible causes further includes: a registration of the user device with a second AMF of the 5G network different from the AMF.

9. The method of claim 8, wherein the plurality of possible causes further includes: a deauthorization of a network slice for the user device by the wireless communication network.

10. The method of claim 9, wherein the plurality of possible causes further includes: a context fetch failure by the AMF and a forced re-registration of the user device by the AMF.

11. The method of claim 2, wherein updating the subscriber profiles with the causes of the deregistering comprises, for each of the user devices, recording a value of an attribute in the subscriber profile associated with the user device, wherein the value corresponds to the cause code.

12. The method of claim 11, further comprising tracking the values of the subscriber profiles to analyze performance of the wireless communication network for optimization.

13. A wireless communication network comprising:
a first network element comprising circuitry configured to manage mobility of user devices within the wireless communication network and to:
deregister the user devices from the wireless communication network;
determine causes of the deregistering;
generate notification messages indicative of the causes of the deregistering of the user devices; and
communicate the notification messages to a second network element, wherein the second network element comprises circuitry configured to manage subscription data handling for the wireless communication network; and
the second network element, wherein the second network element further comprises circuitry to:
receive the notification messages;
responsively purge subscriber data associated with the user devices from a data repository; and
update subscriber profiles associated with the user devices with the causes of the deregistering.

14. The wireless communication network of claim 13, wherein the circuitry of the first network element is further configured to determine, for each of the user devices, a cause of the deregistering from among a plurality of possible causes.

15. The wireless communication network of claim 14, wherein the circuitry of the first network element is further configured to generate, for each of the user devices, a notification message comprising a cause code indicative of the cause of the deregistering.

16. The wireless communication network of claim 15, wherein the wireless communication network comprises a Fifth Generation (5G) network, wherein the first network element comprises an Access and Mobility Management function (AMF) of the 5G network, and wherein the second network element comprises a Unified Data Management function of the 5G network.

17. The wireless communication network of claim 16, wherein the wireless communication network further comprises a long-term evolution (LTE) network, and wherein the plurality of possible causes includes a handover request from a Mobility Management Element of the LTE network.

18. The wireless communication network of claim 17, wherein the plurality of possible causes further includes an initial attachment by the user device to a data repository element of the LTE network.

19. The wireless communication network of claim 18, wherein the plurality of possible causes further includes a registration of the user device with a second AMF of the 5G network different from the AMF.

20. The wireless communication network of claim 19, wherein the plurality of possible causes further includes one of: a deauthorization of a network slice for the user device by the wireless communication network, a context fetch failure by the AMF, and a forced re-registration of the user device by the AMF.
